(19) United States
(12) Patent Application Publication
(10) Pub. No.: US 2013/0117550 A1
(43) Pub. Date: May 9, 2013

(54) ACCESSING SECURE VOLUMES

(71) Applicant: Imation Corp., Oakdale, MN (US)

(72) Inventors: David Alexander Jevans, Los Altos, CA (US); Gil Spencer, Redwood Estates, CA (US)

(73) Assignee: Imation Corp., Oakdale, MN (US)

(21) Appl. No.: 13/724,127

(22) Filed: Dec. 21, 2012

Related U.S. Application Data
(63) Continuation-in-part of application No. 12/537,194, filed on Aug. 6, 2009.
(60) Provisional application No. 61/579,221, filed on Dec. 22, 2011.

(51) Int. Cl. G06F 21/57

(52) U.S. Cl. CPC G06F 21/572
USPC 713/2

(57) ABSTRACT

A system and method for reading data from or writing data to a secure volume of a secure peripheral device. The secure peripheral device is communicatively coupled with a first host computer. The secure peripheral device includes an unsecure first volume, a secure second volume, and a secure third volume. Data is read from or written to the secure third volume either via an operating system stored on the first host computer or via an operating system stored on the secure peripheral device.

### CROSS-REFERENCE TO RELATED APPLICATIONS

The present application claims priority to U.S. Provisional Application No. 61/579,221 filed Dec. 22, 2011 and entitled “Accessing Secure Volumes,” the entirety of which is incorporated by reference herein. The present application is related to U.S. patent application Ser. No. 11/644,089 filed Dec. 21, 2006 and issued Aug. 22, 2012 as U.S. Pat. No. 8,266,378, entitled “Storage Device with Accessible Partitions,” U.S. Provisional Patent Application No. 61/126,473 filed May 2, 2008 and entitled “Enterprise Device Recovery,” U.S. patent application Ser. No. 12/434,628 filed May 2, 2009 and entitled “Enterprise Device Recovery,” U.S. patent application Ser. No. 12/412,844 filed Mar. 27, 2009 and entitled “Establishing a Secure Channel Between a Server and a Portable Storage Device,” abandoned, U.S. patent application Ser. No. 12/537,172 filed Aug. 6, 2009 and entitled “Peripheral Device Data Integrity,” the disclosures of which are incorporated herein by reference. The present application is a continuation in part of U.S. patent application Ser. No. 12/537,194 filed Aug. 6, 2009 and entitled “Running a Computer from a Secure Portable Device,” the entirety of which is incorporated herein by reference.

### BACKGROUND

1. Field of the Invention

The present invention relates generally to data storage devices. More specifically, the present invention relates to a flash drive with multiple data volumes or partitions.

2. Related Art

Modern computers provide for the ability to boot from various peripheral devices. These devices include but are not limited to Universal Serial Bus (USB) flash drives, hard drives, solid-state drives (SSDs), portable SSDs, etc. USB flash drives have enjoyed great popularity in recent years. There are various advantages to running an operating system (OS) on, for example, a USB flash drive. USB flash drives provide for portability. A user can transport a USB flash drive to a different computer, reboot, and resume where the user left off; this can also be accomplished with other types of devices mentioned herein.

Virtual Machines (VMs) allow the sharing of underlying physical machine resources between different operating systems (OSes). Multiple OS environments can co-exist on the same computer, in strong isolation from each other. The VM can provide an instruction set architecture (ISA) that is somewhat different from that of the real machine.

The OSes do not have to be of the same type, making it possible to run different OSes on the same computer (e.g., Linux could be run within Microsoft Windows). The use of VMs to support different guest OSes is becoming popular in embedded systems. Moreover, a guest OS can be run within a host OS without using a VM.

One use of VMs is emulation of the underlying raw hardware (native execution). A VM can run an operating system that is supported by the underlying hardware. Another use of VMs is emulation of a non-native system. VMs can perform the role of an emulator, allowing software applications and OSes written for one computer processor architecture to be run on a computer with a different computer processor architecture.

Presently, various kinds of data can be stored on a peripheral device, such as a USB flash drive, for example. These devices are very lightweight and portable. However, one drawback is that the devices are typically not secure. If lost or stolen, confidential data can be compromised. Consequently, there is a need in the art for an improved secure peripheral device.

### SUMMARY

Embodiments of the present disclosure allow for running a computer from a secure portable device that comprises multiple data volumes or partitions.

In a first claimed embodiment, a method is disclosed for reading data from or writing data to a secure volume of a secure peripheral device. The secure peripheral device is communicatively coupled with a first host computer, and includes an unsecure first volume, a secure second volume, and a secure third volume. Data is read from or written to the secure third volume either via an operating system stored on the first host computer or via an operating system stored on the secure peripheral device. A virtual machine image comprising a virtual operating system or an operating system comprising a real operating system (or real machine operating system) may be stored on and launched from the secure second volume of the secure peripheral device.

In a second claimed embodiment, a system is set forth for reading data from or writing data to a secure volume of a secure peripheral device. The system comprises a first host computer and the secure peripheral device communicatively coupled with the first host computer. The secure peripheral device includes an unsecure first volume, a secure second volume, and a secure third volume. The system further comprises a read/write module configured to read data from or write data to the secure third volume either via an operating system stored on the first host computer or via an operating system stored on the secure peripheral device.

A third claimed embodiment includes a computer readable storage medium having a program embodied thereon. The program is executable by a processor to perform a method for reading data from or writing data to a secure volume of a secure peripheral device. The method comprises communicatively coupling the secure peripheral device with a first host computer. The secure peripheral device includes an unsecure first volume, a secure second volume, and a secure third volume. The method further comprises reading data from or writing data to the secure third volume either via an operating system stored on the first host computer or via an operating system stored on the secure peripheral device.

### BRIEF DESCRIPTION OF THE DRAWINGS

FIG. 1 is a block diagram of an environment for practicing embodiments of the present disclosure.

FIG. 2 is a block diagram of a peripheral device employed in the environment of FIG. 1.

FIG. 3 is a block diagram of a memory included in the peripheral device of FIG. 2.

FIG. 4 is a block diagram of an unsecure first volume included in the peripheral device of FIG. 2.

FIG. 5 is a flowchart of a method for creating an operating environment.

FIG. 6 is a flowchart of an alternate method for creating an operating environment.

FIG. 7 is a flowchart of an alternate method for creating an operating environment.

### DETAILED DESCRIPTION

As mentioned herein, data can be stored on a peripheral device, such as data storage device or a secure data storage device (an external hard drive, SSD, portable SSD, Universal Serial Bus (USB) flash drive, for example). There is a need in the art for an improved system and method that allows for reading data from or writing data to a secure volume of a secure peripheral device. For example, the systems and methods may be utilized for booting or running an operating system (OS) securely, or both, or for accessing storage securely from within a guest operating system, or for a combination of secure booting, secure running, and secure storage access.

In embodiments according to the present disclosure, users are provided with an enhanced experience inside a guest (or secondary) OS (which may or may not be a virtual machine image). Users are able to launch applications from inside a guest OS. Users are also provided with a tertiary secure volume to read to and write from. In some embodiments, users are able to access the same data from either a guest OS or a host OS.

In embodiments according to the present disclosure, the secure peripheral device is communicatively coupled with a first host computer. The secure peripheral device includes an unsecure first volume, a secure second volume, and a secure third volume. Data can be read from or written to the secure third volume either via an operating system stored on the first host computer or via an operating system stored on the secure peripheral device.

In various embodiments, a peripheral device (e.g. a secure peripheral device) can be used to facilitate the execution of a secondary or guest OS (which may comprise a VM image in some embodiments) on a host computer. In some embodiments, a user can carry a portable storage device that stores a first OS (e.g. a host OS) and a secondary OS (e.g. a guest OS), plug the device into a desired host computer, and portably execute onto the host computer a desired secondary OS. The secondary OS might comprise a VM image. The user's applications and data can be included on the peripheral device. This can eliminate the required burden of carrying a laptop around. The peripheral device could include, for example, a hard drive device or a removable hard drive device.

In one embodiment, one or more volumes of the secure peripheral device emulate a CD-ROM to a host computer. One or more volumes can also emulate a hard drive, SSD, portable SSD, or any other suitable device. The CD-ROM emulated image is configured to appear as a bootable CD-ROM. This makes it easy for a user to boot from the device, as one does not have to configure their host BIOS to boot from a USB flash drive. Instead, the user uses the host computer's existing configuration to boot from a first volume of a secure peripheral device. Thus, the first volume presented to the host computer is configured to be bootable by the host computer. In various embodiments, the emulated image may be configured to appear as a CD-ROM, DVD-ROM, or a fixed hard drive. In additional embodiments, two volumes of the secure peripheral device emulate images configured to appear as one or more of a CD-ROM, DVD-ROM, or a fixed hard drive.

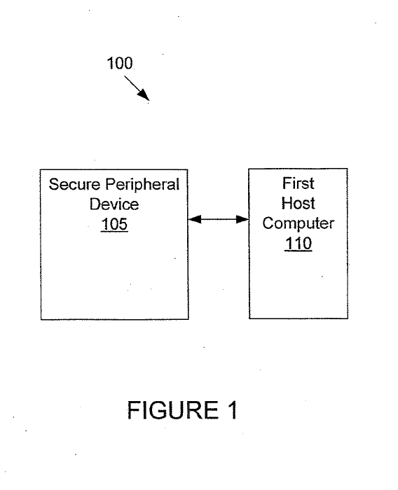

Referring now to FIG. 1, a block diagram of an example environment 100 is presented. As depicted, the environment 100 includes a secure peripheral device 105 and a first host computer 110. The secure peripheral device 105 is communicatively coupled with the first host computer 110. It is noteworthy that communicative couplings may be wireless or wired. In some embodiments, the communicative coupling is accomplished over what is or what will become a secure or encrypted channel or secure or encrypted communication path.

The secure peripheral device 105 includes a device secure channel engine. The first host computer 110, in one embodiment, is communicatively coupled with a network and a server. The server includes a server secure channel engine.

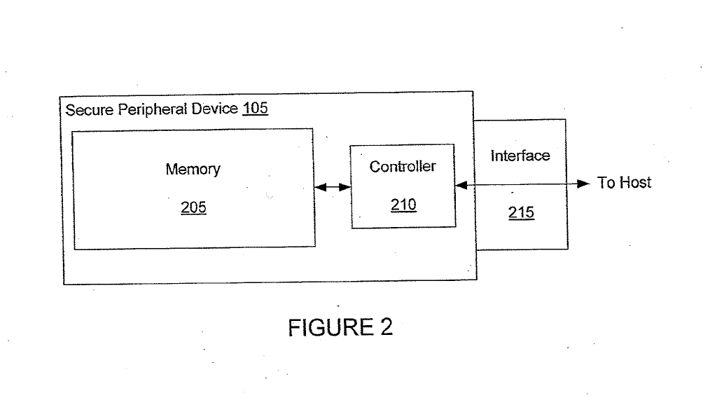

The device secure channel engine includes a device cryptography module, a challenge generation module, a verification module, and a device storage module. Execution of the device cryptography module allows the controller 210 to encrypt and decrypt information stored by the memory 205 (see FIG. 2) and transferred between the secure peripheral device 105 and the server, for example. In some embodiments, the device cryptography module implements one or more of a variety of cryptographic technologies. Examples of cryptographic technologies include symmetric algorithms such as Twofish, Serpent, AES (Rijndael), Blowfish, CASTS, RC4, TDES, and IDEA, as well as asymmetric algorithms that use one key to encrypt given information and another key to decrypt that information. Those skilled in the art will be familiar with symmetric and asymmetric approaches to cryptography. The device cryptography module may also be executable to concatenate information transferred between the secure peripheral device 105 and a server. Concatenation may be achieved through usage of message authentication code (MAC). Generally speaking, MAC describes a hashing mechanism with an associated secret that is used to identify a piece of data.

Execution of the challenge generation module allows the controller 210 to generate a server challenge. The server challenge may include a set of random numbers and be used to confirm an identity of the server. Furthermore, the server challenge is generated through execution of the challenge generation module on numerous occasions. For example, the server challenge may be generated each time a secure channel is established between the secure peripheral device 105 and the server.

Execution of the verification module allows the controller 210 to verify information sent by the server to the secure peripheral device 105. In some embodiments, the verification module is executable to verify signatures applied by the server to transferred information. The verification module may also be executable to verify that a server challenge received back from the server is consistent with a corresponding server challenge initially sent from the secure peripheral device 105 to the server. Additionally, it may be necessary to decrypt such a server challenge returned from the server. Decryption of the server challenge is achieved through execution of the device cryptography module.

The device storage module may be configured to manage information associated with formation of a secure channel between the secure peripheral device 105 and the server. This information may be stored on the controller 210 or the memory 205, and is accessed through execution of the device storage module. In some embodiments, this information includes a device token. The device token may be created when the secure peripheral device 105 is fabricated or at a later time. The device token may include a unique device identification (ID). The device ID includes a series of bytes that identify the secure peripheral device 105, in some embodiments. In addition, the device token may include a public key. In general, public key cryptography is a method for secret communication between two parties without requiring an initial exchange of secret keys. The public key may be one of a set of keys that includes the public key and a private key. The private key may be retained by the secure peripheral device 105. The public key and the private key may be used by the cryptography module to encrypt and decrypt information stored by the memory 205 and transferred between the secure peripheral device 105 and the server.

The server secure channel engine, or certain modules thereof, may be included in the memory and/or storage of the server. The server secure channel engine includes a server cryptography module, a shared secret module, a signature module, and a server storage module.

Execution of the server cryptography module allows the processor of the server to encrypt and decrypt information stored by the memory and storage of the server and transferred between the secure peripheral device 105 and the server. Much like the device cryptography module, the server cryptography module implements one or more of a variety of cryptographic technologies in accordance with exemplary embodiments. The server cryptography module may also be executable to concatenate information transferred between the secure peripheral device 105 and the server.

Execution of the shared secret generation module allows the processor of the server to generate a shared secret. This shared secret may be distributed to the secure peripheral device 105. The shared secret includes an AES key concatenated with a MAC in some embodiments. Those skilled in the art will be familiar with AES keys.

Execution of the signature module allows the processor of the server to digitally sign certain information transferred to the portable storage device 105. In some embodiments, the signature module may utilize an RSA signature. RSA is an algorithm for public key cryptography that is suitable for signing as well as encryption.

The server storage module may be configured to manage information associated with a secure channel formed between the secure peripheral device 105 and the server. This information may be stored by the memory or storage of the server, and is accessed through execution of the server storage module. In some embodiments, this information includes information associated with the secure peripheral device 105. For example, this information may include the device ID of the secure peripheral device 105.

The secure channel (or secure communication path), including the device secure channel engine and the server secure channel engine, are described more fully in U.S. patent application Ser. No. 12/412,844, “Establishing a Secure Channel Between a Server and a Portable Storage Device,” which was referenced above, and the disclosure of which is incorporated by reference herein.

It is contemplated that the secure peripheral device 105 can include any device that is capable of storing digital information. In one embodiment according to aspects of the present disclosure, the secure peripheral device 105 can be a removable or unpluggable data storage device (e.g., a USB drive). The secure peripheral device 105 can be portable in one embodiment, but it is not limited to being a portable device. For illustrative purposes, the secure peripheral device 105 is described herein in the context of a USB flash drive. The secure peripheral device 105 is discussed in further detail in connection with FIG. 2.

The first host computer 110 includes any computing device that can interface with the secure peripheral device 105. Examples of the first host computer 110 include a personal computer (PC), a personal digital assistant (PDA), a Smartphone, and other various devices. The first host computer 110 includes one or more communications interfaces to facilitate communicative coupling with the secure peripheral device 105. Additionally, the first host computer 110 can include a processor, memory such as random access memory (RAM), and storage such as read-only memory (ROM). Those skilled in the art will be familiar with the components and functionality of computing devices such as the first host computer 110.

The first host computer 110 can include a control panel. According to some embodiments, the control panel can be effectuated by instructions that are executed by the processor of the first host computer 110. The control panel can also allow a user to manage digital information stored within the secure peripheral device 105.

These instructions can be stored within the secure peripheral device 105 and retrieved by the first host computer 110 for execution. In one embodiment, these instructions can be stored as software in a control panel module in the secure peripheral device 105. However, it is contemplated that the instructions can be stored as software, firmware, hardware, as a combination, or in various other ways. It is also envisioned that the instructions associated with the control panel can be stored by the first host computer 110, or stored remotely and accessed by the first host computer 110 via a network.

FIG. 2 is a block diagram of the secure peripheral device 105 employed in the environment 100 of FIG. 1. The secure peripheral device 105 can be any device that is that is used to store digital information, and in one embodiment the secure peripheral device 105 is portable. In one embodiment, the secure peripheral device 105 depicted in FIG. 2 includes a memory 205, a controller 210, and an interface 215, which is a USB interface in one embodiment. However, any other types of suitable interfaces can be used.

The memory 205 can include a computer-readable storage medium. While common forms of computer-readable storage media include, for example, a floppy disk, a flexible disk, a hard disk, magnetic tape, any other magnetic medium, a CD-ROM disc, digital video disc (DVD), and any other optical medium, the memory 205 is described in the context of non-volatile memory that can be electrically, optically, magnetically, or otherwise erased and rewritten. Examples of such non-volatile memory include NAND flash and NOR flash memory. Additionally, the memory 205 can comprise other existing memory technologies. The memory 205 can also comprise various other memory technologies as they become available in the future.

The controller 210 can be a processor or microcontroller with an amount of on-chip ROM and/or RAM. The controller 210 is communicatively coupled with the memory 205 and the interface 215. Additionally, the controller 210 can include software and/or firmware that can execute various modules, such as modules described herein. As such, the controller 210 functions as an intermediary between the first host computer 110 and the memory 205. For example, the controller 210, or various modules executed thereby, can receive write commands from the first host computer 110 and determine how data associated with those write commands is to be managed with respect to the memory 205.

As mentioned, the secure peripheral device 105 can be communicatively coupled with the first host computer 110 in either a wireless or wired manner. The interface 215 facilitates this coupling by allowing information to be transferred between the secure peripheral device 105 and the first host computer 110. In some embodiments, the interface 215 includes a USB plug that is insertable into a mating USB port of the first host computer 110. Alternatively, the interface 215 can include other standards for communicative coupling such as FireWire, Ethernet, Wireless USB, eSATA, Bluetooth, or other standards. Furthermore, the interface 215 can comprise other interface technologies as they become available.

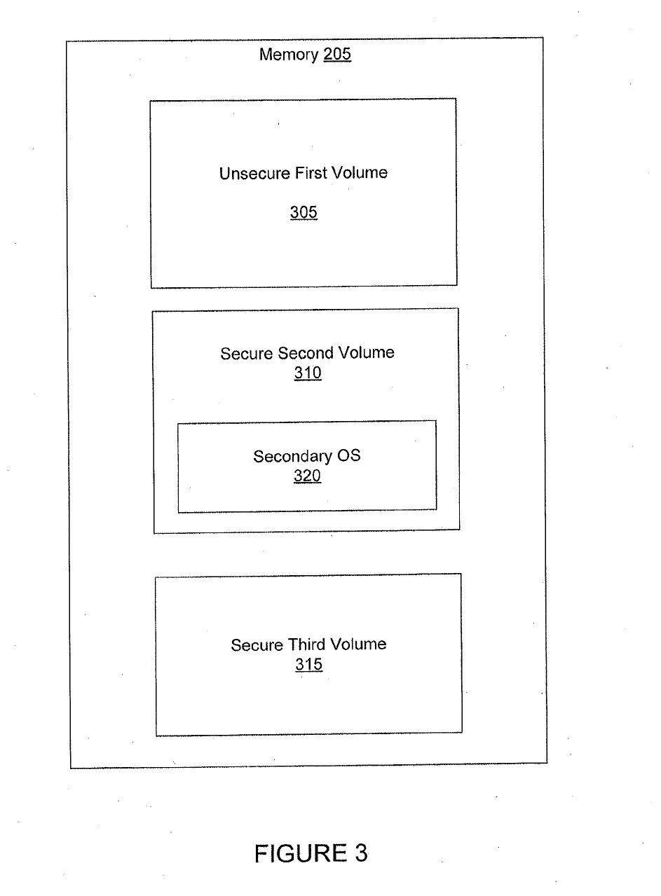

In keeping with embodiments according to the present disclosure, FIG. 3 is a block diagram of the memory 205 included in the secure peripheral device 105 of FIG. 2. The memory 205 includes an unsecure first volume 305 (or unsecure partition, area, or portion of memory) such as a CD volume or CD partition, for example. It should be noted that an area or portion of memory may be a volume or partition in some embodiments.

The memory 205 also includes a secure second volume 310 (or secure partition, area, or portion of memory). In one embodiment, the secure second volume 310 is encrypted. The memory 205 further includes a secure third volume 315 (or secure partition, area, or portion of memory). In one embodiment, the secure third volume 315 is encrypted. The secure third volume 315 may be hidden from one or more users, and/or be rendered inaccessible to one or more users. For example, the secure third volume 315 might be a hidden area of NAND flash memory. It is envisioned that various volumes of the secure peripheral device 105 may be hidden from one or more users, and/or rendered inaccessible to one or more users.

As used herein, the term “unsecure area” or “unsecure volume” can mean, in one embodiment, an area of memory of the secure peripheral device 105 that is accessible without entry of a password, code, or the like. The area does not have access controls. The area may or may not be encrypted, but does not require authentication for access. Alternatively, the term “unsecure area” or “unsecure volume” may refer to an area of memory of the secure peripheral device 105 that includes some level of protection to prevent a user from updating the area. In one embodiment, “unsecure area” or “unsecure volume” may refer to an area of memory emulating a CD-ROM. Alternatively, the term may refer to a read-only hard drive or other suitable device.

As used herein, the term “secure area” or “secure volume” can refer to an area of memory of the secure peripheral device 105 that is encrypted in order to keep unauthorized users from accessing the area. In one embodiment, the term “secure area” or “secure volume” can refer to a secure area of memory or secure volume on the secure peripheral device 105. In another embodiment, the term “secure area” or “secure volume” can refer to an area of memory that may be rendered unwritable and/or unreadable and/or invisible to one or more users.

A guest or secondary OS 320 is stored in the secure second volume 310 in some embodiments. In some embodiments, the secondary OS 320 is a VM image. In an alternate embodiment, the secondary OS 320 or VM image is stored in the unsecure area 305.

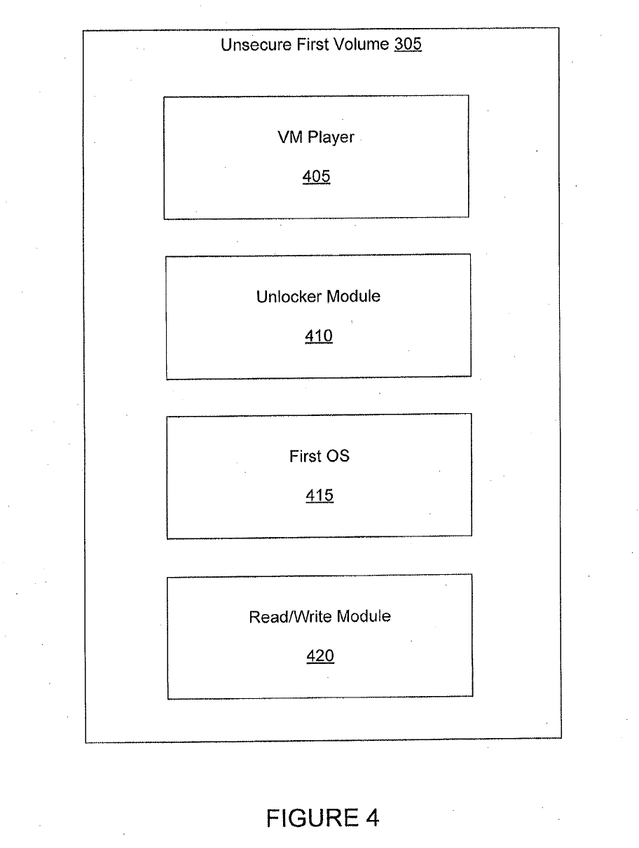

FIG. 4 is a block diagram of the exemplary unsecure first volume 305 included in the secure peripheral device of FIG. 2. In some embodiments, the unsecure first volume 305 includes a VM player 405, an unlocker module 410, and a first OS 415 (which could be considered a host OS and could be a small OS in one embodiment). Modules mentioned herein, such as for example those included in the unsecure first volume 305 and secure second volume 310, can be stored as software, firmware, hardware, as a combination, or in various other ways. It is contemplated that various modules can be removed or included in other suitable locations besides those locations specifically disclosed herein. In various embodiments, additional modules can be included in the exemplary system described herein. It is envisioned that in various embodiments the first OS 415 is not required.

In various embodiments, a read/write module 420 is located in the unsecure first volume 305 or the secure second volume 310. The read/write module 420 can be located in the first OS (on the secure peripheral device 105 or on a host computer) and/or the secondary OS 320. The read/write module 420 can be executed by the controller 210 in one embodiment. The read/write module 420 can be stored elsewhere, such as, for example, on the controller 210, or in other locations or in a combination of locations. The read/write module 420 is configured to facilitate reading data from or writing data to one or more volumes of the secure peripheral device 105. In one embodiment, the read/write module 420 and/or a first (host) and a secondary (guest) OS 415, 320 can include one or more volume block drivers to facilitate reading from and writing to the secure peripheral device 105.

According to one embodiment, the first OS 415 includes a first volume block driver. A first send/listen process in the first OS 415 calls the first volume block driver in order to access the unsecure first volume 305 and secure second volume 310.

In one embodiment, the secondary OS 320 (running from, for example, the secure second volume 310) includes a second volume block driver. The second volume block driver calls a second send/listen process in the secondary OS 320 in order to access the secure third volume 315. The second send/listen process is communicatively coupled with the first send/listen process in a bidirectional manner. It is contemplated that any other suitable technique may be used in order to read and/or write to the volumes. For example, fewer or greater than two volume block drivers may be implemented in various manners.

In keeping with embodiments according to the present disclosure, the VM player 405 is configured to launch (or run) the VM image, which is considered to be a secondary OS (or guest OS) as mentioned herein. In one embodiment, the VM image is specifically node-locked to the VM player 405. The unlocker module 410 is configured to unlock the secure second volume 310 and/or the secure third volume 315 of the memory 205 if a user enters a correct password, for example. The unlocker module 410 is further configured to launch the VM player 405 on the first OS 415. In other embodiments, the first OS 415 launches the VM player 405. In one embodiment, the first OS 415 runs a program that calls the unlocker module 410. The program might first determine if the secure second volume 310 and/or the secure third volume 315 is unlocked, and if so, indicate that no unlocking is currently needed. In another embodiment, a launching module is used to launch the VM player 405.

In one embodiment, the secure third volume 315 is accessed by drivers that are installed on a guest operating system stored on the secure peripheral device 105. The drivers are installed on the guest operating system in lieu of being installed on a host operating system in one embodiment. The accessing of the secure third volume 315 by a driver that is installed on the guest operating system stored on the secure peripheral device 105 includes reading data from and/or writing data to the secure third volume 315.

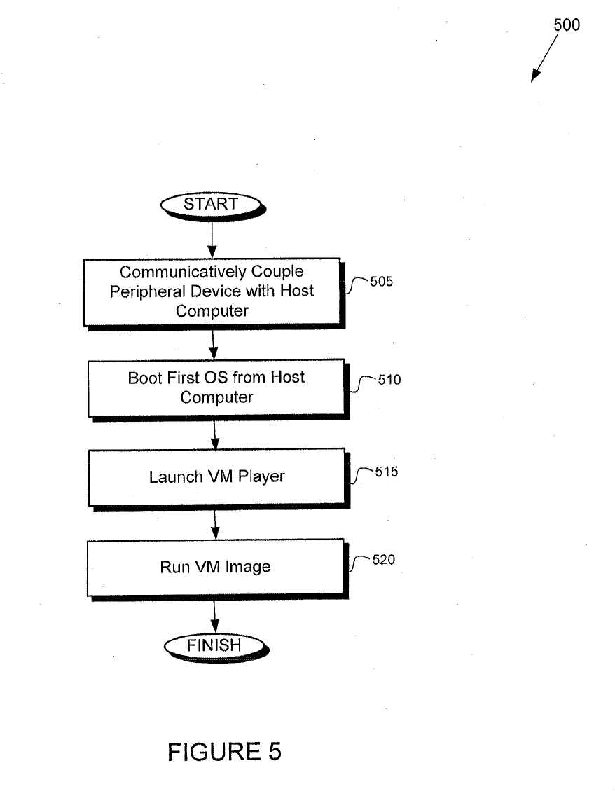

FIG. 5 is a flowchart 500 of a method that allows for reading data from or writing data to a secure volume of secure peripheral device 105. At step 505, the secure peripheral device 105 is communicatively coupled with the first host computer 110, and a secure channel is formed.

At step 510, in one embodiment, a first OS (or host OS) that was previously stored on the first host computer 110 is booted on the first host computer 110.

Next, in one embodiment, the unlocker module 410 in the unsecure first volume 305 can unlock the secure second volume 310 of the secure peripheral device 105. In another embodiment, the unlocking can be done externally. In one embodiment, the first OS 415 communicates over a network to a third-party server to request permission for the secure peripheral device 105 to unlock the secure area and execute the secondary OS 320.

At step 515, the VM player 405 is launched on the first OS on the first host computer 110. The VM player 405 can be launched from the secure second volume 310. Alternatively, the VM player 405 can be launched from the unsecure first volume 305.

At step 520, the VM player 405 launches the secondary OS 320 (which is a VM image in this embodiment) that is stored in the memory 205 of the secure peripheral device 105. The VM image can be stored in the secure second volume 310, the unsecure first volume 305, or in any other suitable location. The VM image is launched on the first host computer 110. The VM image is considered to be the guest OS, or secondary OS 320.

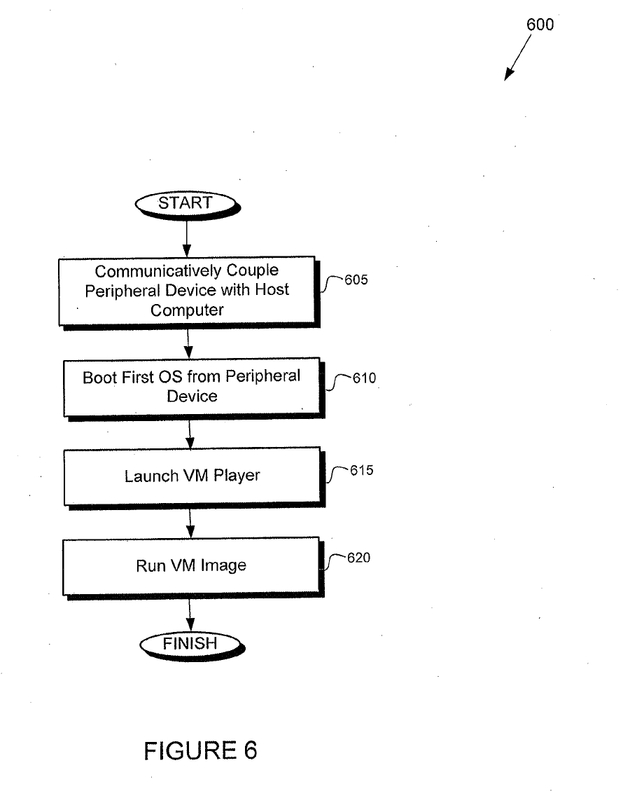

FIG. 6 is a flowchart 600 of an alternate method that allows for reading data from or writing data to a secure volume of secure peripheral device 105. At step 605, the secure peripheral device 105 is communicatively coupled with the first host computer 110, and a secure channel is formed.

At step 610, a first OS 415 (or host OS) is stored on and booted from the memory 205 of the secure peripheral device 105. In one embodiment, the first OS is booted from the unsecure first volume 305 (such as a CD partition) of the memory 205. Next, in one embodiment, the unlocker module 410 in the unsecure first volume 305 can unlock the secure second volume 310 of the secure peripheral device 105 if a user enters a correct password, for example. In another embodiment, the unlocking can be done externally. In one embodiment, the first OS 415 communicates over a network to a third-party server to request permission for the secure peripheral device 105 to unlock the secure second volume 310 and execute the secondary OS 320.

At step 615, the VM player 405 is launched on the first OS on the host computer. The VM player 405 can be launched from the secure second volume 310. Alternatively, the VM player 405 can be launched from the unsecure first volume 305.

At step 620, the VM player 405 launches the secondary OS 320 (which is a VM image in this embodiment) that is stored in the memory 205 of the secure peripheral device 105. The VM image can be stored in the secure second volume 310, the unsecure first volume 305, or in any other suitable location. The VM image 315 is run on the first host computer 110. The VM image is considered to be the guest OS, or secondary OS 320.

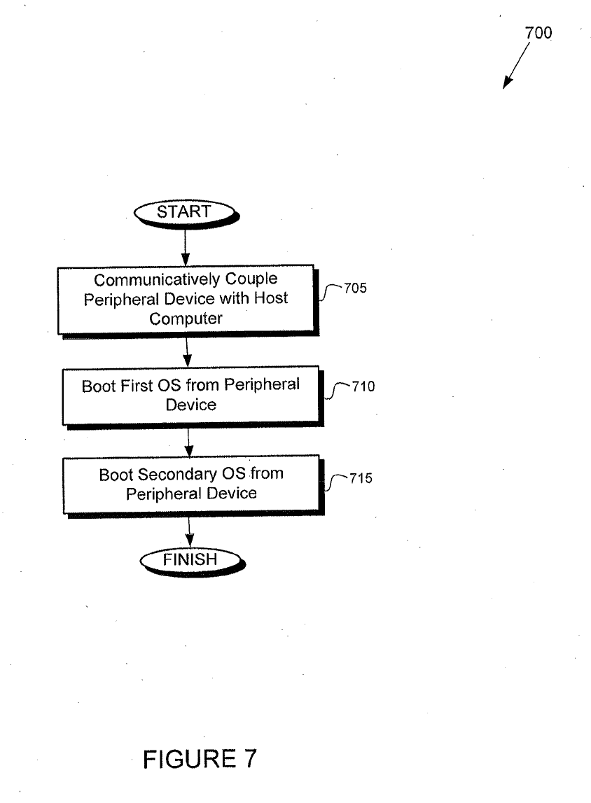

FIG. 7 is a flowchart 700 of an alternate method for booting a secondary OS. In one embodiment, no VM player 405 or VM Image is implemented. At step 705, the secure peripheral device 105 is communicatively coupled with the first host computer 110, and a secure channel is formed.

At step 710, a first OS (or host OS) is booted from the memory 205 of the secure peripheral device 105. In one embodiment, the first OS is booted from the unsecure first volume 305 (such as a CD partition) of the memory 205. However, it is contemplated that the first OS could be stored in the secure second volume 310.

Next, in one embodiment, the unlocker module 410 in the unsecure first volume 305 unlocks the secure second volume 310 of the secure peripheral device 105 if a user enters a correct password, for example.

At step 715, the secondary OS 320 that has been stored in the secure second volume 310, is booted from the secure second volume 310. The secondary OS 320 (which is not a VM image in this particular embodiment) takes over on the first host computer 110, and the first OS 415 is no longer running. Alternatively, the secondary OS 320 expands and the first OS 415 is no longer running.

The user can then write to the secure third volume 315 from a secondary OS or virtual machine image. The read/write module 420 is configured to read data from or write data to the secure third volume 315. This can be accomplished via an operating system stored on the first host computer or via an operating system stored on the secure peripheral device.

In keeping with aspects of the disclosure, in one embodiment, the memory 205 can include a control panel module as mentioned herein. It is envisioned that the control panel module is on the first OS 415 in one embodiment. A user can enter a password into the control panel module, for example, and unlock various volumes of memory of the secure peripheral device 105. In alternate embodiments, the control panel module can be stored in a private area on the secure peripheral device 105 that is not accessible by a user. The control panel module can be an application that includes instructions in the form of, for example, software for running a control panel on the first host computer 110. As mentioned herein, control panel modules are not limited to being software.

In one embodiment, the first OS and the unlocker module can be policy-controlled. The number of password attempts allowed for unlocking the secure area can be controlled by policy on the secure peripheral device 105. The behavior of whether a VM is actually launched or not can be controlled. The behavior of whether the guest OS is launched upon unlocking can be controlled. Various other policies can be set as well.

In one embodiment, it is contemplated that a user can boot from an OS (e.g. Linux), and when the secure area 310 is unlocked the system may be able to extend the OS to take advantage of the storage in the secure area 310 without booting a secondary OS. An advantage of this embodiment is that the user is still booting off of the secure peripheral storage device.

In summary, there are various ways that embodiments according to the present disclosure can be realized, as illustrated in FIGS. 5-7 for example. The secure peripheral device 105 is configured to be communicatively coupled with the first host computer 110 or a second host computer. Various embodiments provide for creating an operating environment that is substantially independent of the first host computer 110 and the second host computer.

For example, a user might plug the secure peripheral device 105 into the first host computer 110. The first host computer 100 might be a trusted host computer at work, for example. The user might have the ability to read from and write to the secure third volume 315 (or other volumes) from either the OS already on the host computer (or host OS) or the secondary OS 320 (which might or might not be a VM image). In some embodiments, depending on policy, etc., the user might not even to be able to see the secure third volume 315 without executing the secondary OS 320 as a virtual machine image.

Subsequently, the user might plug the secure peripheral device 105 into a second host computer at home or in an Internet café, for example. Perhaps the second host computer is not trusted. The user might decide to execute the secondary OS 320 as a virtual machine image if the user has the correct password. Depending on policy and passwords given to or withheld from the user, the user might now be able to see and/or access the secure third volume 315. The access may allow reading and/or writing.

Alternatively, the user might plug the secure peripheral device 105 into a second host computer that is not trusted. The user might decide to execute the secondary OS 320 not as a virtual machine image, but instead by booting the secondary OS 320. Depending on policy and passwords given to or withheld from the user, the user might not be able to see and/or access the secure third volume 315. The access might allow reading and/or writing.

Thus, in some embodiments, a system is envisioned that controls access to one or more secure volumes. This can be accomplished using a first (or host) OS, or a secondary OS (which might or might now be a VM image). It is envisioned that a plurality of secure and/or unsecure volumes can be included on a single secure peripheral device 105. Different users can be given different permissions and/or passwords to access different (or the same or overlapping) secure volumes or sets of secure volumes. For example, a user might attempt to read data from or write data to the secure third volume 315 via an operating system stored on the first host computer. This user might be required to enter a password in order to do so. It is also contemplated that data integrity checks can be implemented with embodiments according to the present disclosure.

In one embodiment, the secure third volume 315 can only be accessed by an operating system stored on the secure peripheral device 105, and is inaccessible to a host operating system on the first host computer 110.

In one embodiment, user files are stored on the secure third volume 315 and an operating system is stored on the secure second volume 320. Access by a guest operating system to a storage device communicatively coupled with the first host computer 110 can be controlled by a policy, and the policy can be controlled or updated over a network. In another embodiment, access by a guest operating system to a storage device communicatively coupled with the first the host computer 110 can be controlled by a user of the first host computer 110 and the secure peripheral device 105. It is contemplated that all data downloaded from a network can be stored on the secure third volume 315.

Thus, a system and method have been disclosed that allow for reading data from or writing data to a secure volume of a secure peripheral device. In embodiments according to the present disclosure, the secure peripheral device is communicatively coupled with a first host computer. The secure peripheral device includes an unsecure first volume, a secure second volume, and a secure third volume. Data can be read from or written to the secure third volume either via an operating system stored on the first host computer or via an operating system stored on the secure peripheral device. In other words, a user can write to a hidden secure volume from a virtual machine image or secondary OS.

By storing a user's files on the secure third volume 315, and controlling the ability for the guest operating system to access storage devices on the host computer, it is possible to ensure that no data can be leaked (e.g., copied) from the secure peripheral device to a host computer, and vice versa. In one embodiment, this “data leak prevention” technique ensures that users can work securely from the device, and cannot have their data copied to the host computer. Furthermore, by controlling this by policy (for example, allowing the secure third volume 315 to be accessible to host operating systems on certain trusted computers, or alternatively allowing the guest operating system to access storage devices on the host computer on certain trusted computers), one can allow users to copy files back and forth from a work computer, but fully protect that data from leaking when working on un-trusted computers or on un-trusted networks.

While various embodiments have been described above, it should be understood that they have been presented by way of example only, and not limitation. The descriptions are not intended to limit the scope of the invention to the particular forms set forth herein. Thus, the breadth and scope of a preferred embodiment should not be limited by any of the above-described embodiments.

It should also be understood that the above description is illustrative and not restrictive. To the contrary, the present descriptions are intended to cover such alternatives, modifications, and equivalents as may be included within the spirit and scope of the invention as defined by the appended claims and otherwise appreciated by one of ordinary skill in the art. The scope of the invention should, therefore, be determined not with reference to the above description, but instead should be determined with reference to the appended claims along with their full scope of equivalents.

What is claimed is:

1. A method for reading data from or writing data to a secure volume of a secure peripheral device, the method comprising:
communicatively coupling the secure peripheral device with a first host computer, the secure peripheral device including an unsecure first volume, a secure second volume, and a secure third volume; and
reading data from or writing data to the secure third volume either via an operating system stored on the first host computer or via an operating system stored on the secure peripheral device.

2. The method of claim 1, wherein one or both of the secure second volume and the secure third volume comprises an area of memory that can be hidden from a user.

3. The method of claim 1, wherein the secure third volume comprises an area of memory that can be made inaccessible to a user.

4. The method of claim 1, wherein the secure third volume can only be accessed by an operating system stored on the secure peripheral device, and is inaccessible to a host operating system on the host computer.

5. The method of claim 1, wherein the secure third volume is accessed by drivers that are installed on a guest operating system stored on the secure peripheral device.

6. The method of claim 5, wherein the drivers are installed on the guest operating system in lieu of being installed on a host operating system.

7. The method of claim 5, wherein accessing the secure third volume by a driver that is installed on the guest operating system stored on the secure peripheral device includes reading data from the secure third volume.

8. The method of claim 5, wherein accessing the secure third volume by a driver that is installed on the guest operating system stored on the secure peripheral device includes writing data to the secure third volume.

9. The method of claim 1, wherein user files are stored on the secure third volume and an operating system is stored on the secure second volume.

10. The method of claim 1, wherein access by a guest operating system to a storage device communicatively coupled with the first host computer can be controlled by a policy, and the policy can be controlled or updated over a network.

11. The method of claim 1, wherein access by a guest operating system to a storage device communicatively coupled with the first host computer can be controlled by a user of the first host computer and the secure peripheral device.

12. The method of claim 1, wherein data downloaded from a network is stored on one or both of the secure second volume and the secure third volume.

13. The method of claim 1, wherein a first operating system is stored on and booted from the first host computer and a secondary operating system is a virtual machine image stored on and launched from the secure peripheral device.

14. The method of claim 13, wherein the virtual machine image comprises a virtual operating system stored on and launched from the secure second volume of the secure peripheral device.

15. The method of claim 13, wherein the operating system comprises a real operating system stored on and launched from the secure second volume of the secure peripheral device.

16. The method of claim 1, wherein a first operating system is stored on and booted from the secure peripheral device and a secondary operating system is a virtual machine image stored on and launched from the secure peripheral device.

17. The method of claim 16, wherein the first operating system is stored on and booted from the unsecure first volume of the secure peripheral device.

18. The method of claim 16, wherein the virtual machine image is stored on and launched from the secure second volume of the secure peripheral device.

19. The method of claim 1, wherein a first operating system is stored on and booted from the secure peripheral device and a secondary operating system is stored on and booted from the secure peripheral device.

20. The method of claim 19, wherein the first operating system is stored on and booted from the unsecure first volume of the secure peripheral device.

21. The method of claim 19, wherein the secondary operating system is stored on and booted from the secure second volume of the secure peripheral device.

22. A system for reading data from or writing data to a secure volume of a secure peripheral device, the system comprising:
a first host computer;
the secure peripheral device communicatively coupled with the first host computer, the secure peripheral device including an unsecure first volume, a secure second volume, and a secure third volume; and
a read/write module configured to read data from or write data to the secure third volume either via an operating system stored on the first host computer or via an operating system stored on the secure peripheral device.

23. The system of claim 22, wherein the secure third volume comprises an area of memory that can be hidden from a user.

24. The system of claim 22, wherein the secure third volume comprises an area of memory that can be made inaccessible to a user.

25. The system of claim 22, wherein a first operating system is stored on and booted from the first host computer and a secondary operating system is a virtual machine image stored on and launched from the secure peripheral device.

26. The system of claim 25, wherein the virtual machine image is stored on and launched from the secure second volume of the secure peripheral device.

27. The system of claim 22, wherein a first operating system is stored on and booted from the secure peripheral device and a secondary operating system is a virtual machine image stored on and launched from the secure peripheral device.

28. The system of claim 27, wherein the first operating system is stored on and booted from the unsecure first volume of the secure peripheral device.

29. The system of claim 27, wherein the virtual machine image is stored on and launched from the secure second volume of the secure peripheral device.

30. The system of claim 22, wherein a first operating system is stored on and booted from the secure peripheral device and a secondary operating system is stored on and booted from the secure peripheral device.

31. The system of claim 30, wherein the first operating system is stored on and booted from the unsecure first volume of the secure peripheral device.

32. The system of claim 30, wherein the secondary operating system is stored on and booted from the secure second volume of the secure peripheral device.

33. A non-volatile computer readable storage medium having a program embodied thereon, the program executable by a processor to perform a method for reading data from or writing data to a secure volume of a secure peripheral device, the method comprising:
communicatively coupling the secure peripheral device with a first host computer, the secure peripheral device including an unsecure first volume, a secure second volume, and a secure third volume; and
reading data from or writing data to the secure third volume either via an operating system stored on the first host computer or via an operating system stored on the secure peripheral device.
